(19) United States
(12) Patent Application Publication
(10) Pub. No.: US 2011/0159232 A1
(43) Pub. Date: Jun. 30, 2011

(54) FLAME RETARDANT POLY(TRIMETHYLENE TEREPHTHALATE) COMPOSITIONS

(75) Inventor: Dennis Gerard Madeleine, Wilmington, DE (US)

(73) Assignee: E. I. DU PONT DE NEMOURS AND COMPANY, Wilmington, DE (US)

(21) Appl. No.: 12/980,434

(22) Filed: Dec. 29, 2010

Related U.S. Application Data
(60) Provisional application No. 61/290,994, filed on Dec. 30, 2009.

(51) Int. Cl. C08K 5/5357; D05C 17/02

(52) U.S. Cl. 428/97; 524/117

(57) ABSTRACT

Provided are polyester compositions comprising poly(trimethylene terephthalate) and flame retardant additives that are phosphonic acid esters. The compositions can be used to make articles having reduced flammability and reduced yellowness as compared to conventional poly(trimethylene terephthalate) compositions.

### FIELD OF THE INVENTION

The present invention relates to flame retardant poly(trimethylene terephthalate) compositions comprising certain phosphonic acid ester compounds as flame retardant additives.

### BACKGROUND

Poly(trimethylene terephthalate) (“PTT”) is generally prepared by the polycondensation reaction of 1,3-propanediol with terephthalic acid or terephthalic acid esters. Poly(trimethylene terephthalate) polymer, when compared to poly(ethylene terephthalate) (“PET”, made with ethylene glycol as opposed to 1,3-propane diol) or poly(butylene terephthalate) (“PBT”, made with 1,4-butane diol as opposed to 1,3-propane diol), is superior in mechanical characteristics, weatherability, heat aging resistance and hydrolysis resistance.

Poly(trimethylene terephthalate), poly(ethylene terephthalate) and poly(butylene terephthalate) find use in many application areas (such as carpets, home furnishings, automotive parts and electronic parts) that require a certain flame retardance. It is known that poly(trimethylene terephthalate) may, under certain circumstances, have insufficient flame retardance, which currently limits is use in some application areas. US 2004/00198878 A2 discloses a flame retardant PTT resin composition that contains in part condensed phosphate ester compounds. While the phosphate ester fire retardants are known to impart adequate reduced flammability, for some applications it is desired to reduce flammability even further. In addition, some phosphate esters can impart an undesired yellow color to poly(trimethylene terephthalate) (PTT). The yellowness is particularly unacceptable in PTT articles where low yellowness is desired, such as apparel fabrics and carpets. Fabrics and carpets made with polymers having high yellowness may have an undesirable appearance after dyeing.

PCT Patent Publication No. WO2002053819 discloses an insulating element comprising a mineral fiber layer which is at least partially coated with a fibrous web essentially consisting of polymer fibers selected from the group of polytrimethylene terephthalate, polybutylene terephthalate, polyethylene terephthalate and polamide fibers and a flame retardant in the form of a cyclic phosphonic acid ester.

There remains a need to provide poly(trimethylene terephthalate) compositions with improved flame retardancy properties as well as reduced yellowness. It is also desirable to provide such compositions with reduced toxicity, to reduce environmental impact of disposal.

### SUMMARY OF THE INVENTION

One aspect of the present invention is a poly(trimethylene terephthalate)-based composition comprising: (a) from about 95 to about 99.5 weight percent of a polymer component based on the total weight of the composition, the polymer component comprising at least about 70 weight percent poly(trimethylene terephthalate) based on the weight of the polymer component, and (b) from about 0.5 to 5 weight percent of one or more cyclic phosphonic acid ester flame retardant compound. In preferred embodiments, the composition has reduced yellowness, as compared to the composition in the absence of the phosphonic acid ester compounds.

Another aspect of the present invention is a process for preparing a poly(trimethylene terephthalate)-based composition, comprising: a) providing (1) one or more cyclic phosphonic acid ester compound; and (2) polytrimethylene terephthalate; b) mixing the polytrimethylene terephthalate and the cyclic phosphonic acid ester compound to form a mixture; and c) heating and blending the mixture with agitation to form the composition.

### DETAILED DESCRIPTION

According to embodiments of the present invention, there are provided polyester compositions containing one or more flame retardant additives. It has been surprisingly found that the presence of the flame retardant additives also provides reduced yellowness of the compositions as compared to the polyester compositions without the flame retardant additives. The polyester compositions comprise poly(trimethylene terephthalate) and one or more phosphonic acid ester compounds, particularly cyclic phosphonic acid ester compounds. The compositions have reduced flammability and reduced yellowness when compared to polyester compositions which do not contain the phosphonic ester compounds.

In some embodiments, a poly(trimethylene terephthalate)-based composition comprises: (a) from about 95 to about 99.5 weight percent of a polymer component, the polymer component comprising at least about 70 weight percent poly(trimethylene terephthalate) based on the weight of the polymer component, and (b) from about 0.5 to 5 weight percent of a cyclic phosphonic acid ester flame retardant compound, based on the total weight of the composition.

As indicated above, the polymer component (and composition as a whole) comprises a predominant amount of a poly(trimethylene terephthalate).

Poly(trimethylene terephthalate)s suitable for use in the compositions disclosed herein are well known in the art, and can be prepared, for example, by polycondensation of 1,3-propane diol with terephthalic acid or terephthalic acid equivalent. In some preferred embodiments the 1,3-propane diol is obtained biochemically from a renewable source (“biologically-derived” 1,3-propanediol).

By “terephthalic acid equivalent” is meant compounds that perform substantially like terephthalic acids in reaction with polymeric glycols and diols, as would be generally recognized by a person of ordinary skill in the relevant art. Terephthalic acid equivalents include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are disclosed, for example, in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638,919).

Preferably the 1,3-propanediol used as a reactant or as a component of the reactant in making poly(trimethylene terephthalate) has a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

Poly(trimethylene terephthalate)s suitable for use in the methods and compostions disclosed herein can be poly(trimethylene terephthalate) homopolymers (derived substantially from 1,3-propane diol and terephthalic acid and/or equivalent) and copolymers. Optionally, the homopolymers and/or copolymers can be blended with one another or with other polymers. Preferred poly(trimethylene terephthalate)s contain about 70 mole % or more of repeat units derived from 1,3-propane diol and terephthalic acid (and/or an equivalent thereof, such as dimethyl terephthalate).

The poly(trimethylene terephthalate) can contain up to 30 mole % of repeat units made from other diols or diacids. Other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. Other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

The poly(trimethylene terephthalate) polymers can also include functional monomers, for example, up to about 5 mole % of sulfonate compounds useful for imparting cationic dyeability. Specific examples of preferred sulfonate compounds include 5-lithium sulfoisophthalate, 5-sodium sulfoisophthalate, 5-potassium sulfoisophthalate, 4-sodium sulfo-2,6-naphthalenedicarboxylate, tetramethylphosphonium 3,5-dicarboxybenzene sulfonate, tetrabutylphosphonium 3,5-dicarboxybenzene sulfonate, tributyl-methylphosphonium 3,5-dicarboxybenzene sulfonate, tetrabutylphosphonium 2,6-dicarboxynaphthalene-4-sulfonate, tetramethylphosphonium 2,6-dicarboxynapthalene-4-sulfonate, ammonium 3,5-dicarboxybenzene sulfonate, and ester derivatives thereof such as methyl, dimethyl, and the like.

More preferably, the poly(trimethylene terephthalate)s contain at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate) homopolymer (polymer of substantially only 1,3-propane diol and terephthalic acid or equivalent).

The polymer component can contain additional polymer or polymers blended with the poly(trimethylene terephthalate), such as, for example, poly(ethylene terephthalate) (PET), poly(butylene terephthalate) (PBT), of a nylon such nylon-6 and/or nylon-6,6, and preferably contains at least about 70 weight percent, or at least about 80 weight percent, or at least about 90 weight percent, or at least about 95 weight percent, or at least about 99 weight percent, poly(trimethylene terephthalate) based on the weight of the polymer component. In one preferred embodiment, poly(trimethylene terephthalate) is used without such other polymers.

The poly(trimethylene terephthalate)-based compositions can contain additives such as antioxidants, residual catalyst, delusterants (such as TiO₂, zinc sulfide or zinc oxide), colorants (such as dyes), stabilizers, fillers (such as calcium carbonate), antimicrobial agents, antistatic agents, optical brighteners, extenders, processing aids and other functional additives, hereinafter referred to as “chip additives”. When used, TiO₂ or similar compounds (such as zinc sulfide and zinc oxide) are used as pigments or delusterants in amounts normally used in making poly(trimethylene terephthalate) compositions, that is up to about 5 weight percent or more (based on total composition weight) in making fibers and larger amounts in some other end uses. When used in polymer for fibers and films, TiO₂ is added in an amount of preferably at least about 0.01 weight percent, more preferably at least about 0.02 weight percent, and preferably up to about 5 weight percent, more preferably up to about 3 weight percent, and most preferably up to about 2 weight percent (based on total composition weight).

By “pigment” as used herein is meant those substances commonly referred to as pigments in the art. Pigments are substances, usually in the form of a dry powder, that impart color to the polymer or article (e.g., chip or fiber). Pigments can be inorganic or organic, and can be natural or synthetic. Generally, pigments are inert (e.g., electronically neutral and do not react with the polymer) and are insoluble or relatively insoluble in the medium to which they are added, in this case the poly(trimethylene terephthalate) composition. In some instances they can be soluble.

When the polymer component and flame retardant additive(s) are melt blended, they are mixed and heated at a temperature sufficient to form a melt blend, and spun into fibers or formed into shaped articles, preferably in a continuous manner. The ingredients can be formed into a blended composition in many different ways. For instance, they can be (a) heated and mixed simultaneously, (b) pre-mixed in a separate apparatus before heating, or (c) heated and then mixed. The mixing, heating and forming can be carried out by conventional equipment designed for that purpose such as extruders, Banbury mixers or the like. The temperature should be above the melting points of each component but below the lowest decomposition temperature, and accordingly can be adjusted for any particular composition of PTT and flame retardant additive. The temperature is typically in the range of about 180° C. to about 270° C.

When the flame retardant additive(s) is a liquid, it can be added to the polymer component via liquid injection. Generally, this can be accomplished by using a syringe pump (e.g., Isco Syringe Pump, Model 1000D, Isco, Lincoln, Nebr.). The pressure used for injection is generally chosen to facilitate smooth addition of the additive to the polymer.

The cyclic phosphonic acid ester compounds used in the present embodiments are blended into the polyester, particularly poly(trimethylene terephthalate) by any of these methods. One typical way to achieve the blend of the cyclic phosphonic acid ester compound with the polyester (typically dried polymer pellets) is to employ a twin screw extruder equipped with a syringe pump. Because the cyclic phosphonic esters tend to have relatively high viscosity, they can be pre-heated before introduction into the twin screw extruder via a syringe pump.

Flame retardants of the type used in the embodiments disclosed herein preferably comprise one or more phosphonic acid esters (also known as phosphonates) having the formula

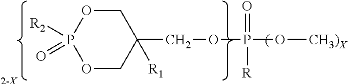

where R, R¹ and R² are each independently an alkyl group having from 1 to 4 carbon atoms, and x=0 or 1. Oligomers of the cyclic phosphonic acid esters can be present in compositions containing the cyclic phosphonic acid esters, and such compositions are intended to be within the scope of some embodiments of the present invention.

Various cyclic phosphonic acid esters can be realized from the structure above depending on the choice of the R, R¹ and R² groups and the value of X. One compound is represented by the structure FR 3 below, when R, R¹ and R² are each CH₃ and X is 1. It can be acquired as Amgard CU from Rhodia Inc., Cranbury, N.J. Another compound is represented by the structure shown as FR 4, in which R, R¹ and R² are each CH₃ and X is 0. and which can be acquired as Amgard 1045 from Rhodia, Inc, Cranbury, N.J. Additionally, combinations of FR3 and FR4 can be used.

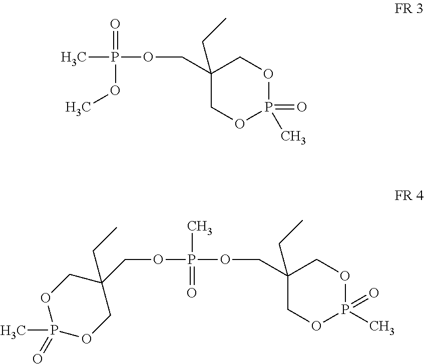

Generally, these compounds are useful in amounts from 0.5 to 5.0 weight percent based on the total weight of the polyester/flame retardant composition. They are more typically used in amounts ranging from 1.5 to 3.5 percent by weight of the polyester/flame retardant composition.

For some applications, it is desirable to have reduced yellowness in the polymer compositions containing fire retardant compounds. Yellowness is measured by the b* value on the L*a*b* scale, where higher b* values indicate higher yellowness, and lower b* values indicate lower yellowness. As shown in the examples herein, the yellowness of the poly(trimethylene terephthalate) materials made with the cyclic phosphonic acid esters showed reduced yellowness when compared to other poly(trimethylene terephthalate) made with or without other flame retardant compounds.

Also provided in some embodiments are articles and fibers comprising the poly(trimethylene terephthalate) composition, such articles having improved flame retardant properties.

The poly(trimethylene terephthalate)-based compositions are useful in fibers, fabrics, films and other useful articles, and methods of making such compositions and articles, as disclosed in a number of the previously cited references. They can be used, for example, for producing continuous and cut (e.g., staple) fibers, yarns, and knitted, woven and nonwoven textiles. The fibers can be monocomponent fibers or multicomponent (e.g., bicomponent) fibers, and can have a variety of different shapes and forms. Examples of applications for the fibers include textiles and flooring, e.g, tufted or woven carpets or rugs. In a particularly preferred embodiment, the poly(trimethylene terephthalate)-based compositions can be used in the making of fibers for carpets, such as disclosed in U.S. Pat. No. 7,013,628.

### EXAMPLES

In the following examples, all parts, percentages, etc., are by weight unless otherwise indicated.

### Ingredients

The poly(trimethylene terephthalate) (PTT) used in the examples was SORONA® “semi-bright” (0.12 weight percent titanium dioxide) polymer available from E.I. du Pont de Nemours and Company (Wilmington, Del.).

### Drying of Polymer Pellets

PTT polymer pellets containing 0.12% titanium dioxide and with an intrinsic viscosity of 1.02 dL/g was acquired from the E.I. DuPont Company (Wilmington, Del.). PTT pellets were dried for 12 hours under a nitrogen atmosphere at reduced pressure (25 inches of vacuum) and 120° C. Under these conditions the pellet moisture content is reduced to less than 40 ppm. The dried pellets were used in the extrusion process described below.

### Fire Retardants

Four commercially available fire retardants were evaluated, and are shown in the structures below. Phosphate ester fire retardant that is made primarily of the structure shown as FR 1 can be referred to by the chemical name resorcinol bis-diphenyl phosphate (RDP), and can be acquired as FYROFLEX RDP from Supestra, Ardsley, N.Y. Fire retardant that is primarily made of the structure shown as FR 2 can be referred to by the chemical name bisphenol A bis diphenyl phosphate (BDP), and can be acquired as FYROFLEX BDP from Supresta Inc., Ardsley, N.Y.

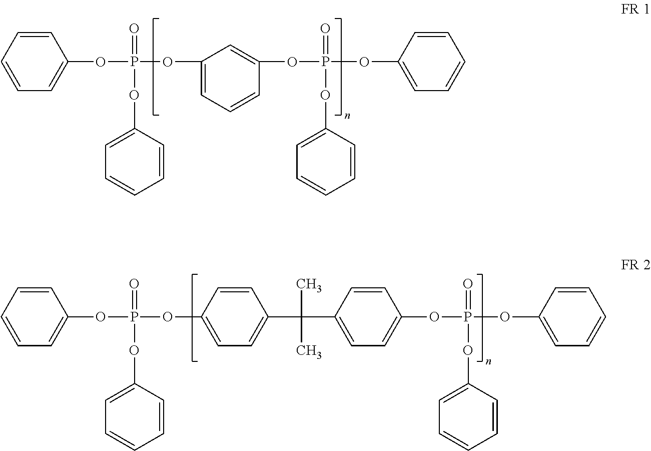

Phosphonate fire retardant that is made primarily of the structure shown as FR 3 can be acquired as Amgard CU from Rhodia Inc., Cranbury, N.J. Phosphonate fire retardant that is made primarily of the structure shown as FR 4 can be acquired as Amgard 1045 from Rhodia, Inc, Cranbury, N.J.

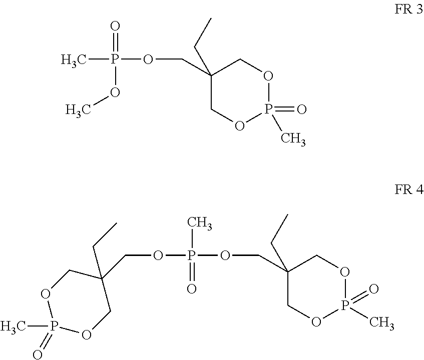

FR 1 is a low viscosity liquid at room temperature and was injected into the mixing section of a 30 mm Werner and Pfleiderer twin screw extruder using a Teledyne Isco D Series syringe pump (model number DX100). The operating conditions for the extruder are listed in Table 1. The volumetric output of FR 1 from the syringe pump was matched to the extruder throughput so that the proper proportion of FR 1 in PTT could be obtained. For example, 0.457 lbs per hour of FR 1 was pumped into the twin screw extruder operating at a PTT throughput rate of 30 pounds per hour. In this way, a mixture of 1.5% FR 1 in PTT (weight percent) was obtained. The extrudate was cooled under water in a 15 foot cooling trough forming a continuous strand that was taken up and chopped into pellets by a pelletizer (Conair Model number 340). The pellet size was approximately 3.5 mm×3.5 mm×1.5 mm.

TABLE 1
Extruder Operating Conditions

| Extruder Zone | Temperature, ° C. |
|---|---|
| Feed Barrel | 25 |
| Zone 2 | 180 |
| Zone 3 | 255 |
| Zone 4 | 255 |
| Zone 5 | 255 |
| Zone 6 | 255 |
| Zone 7 | 255 |
| Zone 8 | 255 |
| Zone 9 | 255 |
| Die | 255 |
| Screw rpm | 200 |
| Vacuum, in mmHg | 28 |
| Pellet feed rate, | 30 |
| lb/hr | |

By using the above procedure, the fire retardants FR 1, 2, 3 and 4 were all individually blended with PTT, the PTT incorporated at 1.5, 2.5 and 3.5% (weight percent fire retardant in polymer). To facilitate pumping into the extruder, the highly viscous FR 3 and FR 4 were heated for 12 hours in an oven under nitrogen to a temperature of 80-100° C. before being transferred to the pump. About 10 lbs. of pellets were made at the four different quantities of incorporation (0, 1.5, 2.5 and 3.5 weight percent) for FR 1, 2, 3 and 4.

### Flammability Testing

In order to provide an appropriate sample for testing flame retardancy, each FR/PTT blend was molded into about 15 test bars on an Arburg 221K molding machine. The operating conditions for the molding machine are shown in Table 2. One end of the dog-bone shaped test bar was removed to provide a test specimen of 10 mm in width, 4 mm in thickness and a length of at least 80 mm. The resulting sample geometry is in accordance with test specimen Type 1 in ASTM D2863-08 “Standard Test Method for Measuring the Minimum Oxygen Concentration to Support Candle-Like Combustion of Plastics (Oxygen Index)”. A Stanton Redcroft Model FTA flammability tester was used to acquire the limiting oxygen index (LOI) value for each test specimen as per ASTM D2863-08. The LOI values reported are the average of the last 5 measurements. LOI is a measure of the percent oxygen content in the ambient atmosphere required to sustain burning. Therefore, a higher LOI value indicates a higher ambient oxygen concentration and a reduced flammability. Therefore, a high LOI value is preferred.

TABLE 2
Molding Machine Operating Conditions

| Parameter | Temperature, ° C. |
|---|---|
| Zone temperature 1 | 249 |
| Zone temperature 2 | 250 |
| Zone temperature 3 | 250 |
| Zone temperature 4 | 250 |
| nozzle | 250 |
| mold | 90 |
| injection, sec | 30 |
| cooling, sec | 10 |
| Dosage, grams | 5 |

TABLE 3
LOI
LOI Values

| | FR 1 | FR 2 | FR 3 | FR 4 |
|---|---|---|---|---|
| 0 | 24.0 | 24.0 | 24.0 | 24.0 |
| 1.5 | 25.3 | 25.7 | 26.6 | 27.3 |
| 2.5 | 26.0 | 25.3 | 27.4 | 27.9 |
| 3.5 | 27.0 | 24.8 | 27.5 | 28.2 |

### Yellowness

Pellet yellowness was measured on a Hunter Lab Color Quest XE. ASTM method D2244-93 (2000) “Standard Method for Calculation of Color Differences from Instrumentally Measured Color Coordinates” was used to measure the degree of yellowness (b* Color) and the average of five readings is reported. Higher positive values of b* color correlate with increased yellowness. Therefore a relatively low (but positive) b* color is desired.

TABLE 4
b* Color
B Color

| | FR 1 | FR 2 | FR 3 | FR 4 |
|---|---|---|---|---|
| 0 | 8.2 | 8.2 | 8.2 | 8.2 |
| 1.5 | 12.3 | 14.3 | 5.6 | 5.7 |
| 2.5 | 13.0 | 13.5 | 5.7 | 5.6 |
| 3.5 | 13.4 | 11.7 | 5.9 | 5.6 |

### Discussion

The LOI data in Table 3 indicate that even a 1.5% loading of FR 1, 2, 3 and 4 in PTT are useful in improving the LOI value and reducing the flammability of PTT. Also, increasing the amount of FR up to 3.5% usually increases the LOI value. The data also indicate that the phosphonates (FR 3 and 4) are more effective at improving the LOI and hence the flammability resistance than the phosphates (FR 1 and 2) at all levels of incorporation studied. Therefore, the phosphonate fire retardants FR 3 and FR 4 are preferred over the phosphate fire retardants FR 1 and FR 2.

The b* color is a measure of yellowness and the color results for the FR polymer bends are shown in Table 4. It is undesirable to impart color into PTT or any other polymer where low color is of value. PTT control without any FR has an average B color value of 8.2 units. However, adding F1 actually increases the color. Similarly FR 2 also increases the average B color value By contrast, both F3 and F4 decrease the yellowness of the PTT. It was also surprising to observe that the phosphonate fire retardants FR 3 and FR 4 lower the yellowness compared to the control.

The observation that phosphonates of the type FR 3 and FR 4 are superior flame retardants as compared to the phosphate fire retardants of the type FR 1 and FR 2 as measured by LOI was unexpected. Additionally, the observation that phosphonates of type FR 3 and FR 4 reduced yellowness as compared to the phosphate fire retardants of the type FR 1 and FR 2 as measured by b* color values was also unexpected.

What is claimed is:

1. A poly(trimethylene terephthalate)-based composition comprising: (a) from about 95 to about 99.5 weight percent of a polymer component wherein the weight percent of the polymer component is based on the total composition comprising at least about 70 weight percent of a poly(trimethylene terephthalate) based on the polymer component, and (b)) from about 0.5 to 5 weight percent of a cyclic phosphonic acid ester flame retardant compound.

2. The poly(trimethylene terephthalate)-based composition of claim 1, comprising from about 1.5 to 3.5 weight percent of a cyclic phosphonic acid ester flame retardant compound.

3. The poly(trimethylene terephthalate)-based composition of claim 2, wherein said cyclic phosphonic acid ester flame retardant compound comprises one or more compounds of the formula 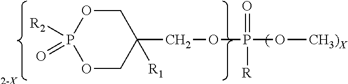
where R, R¹ and R² are each independently an alkyl group having from 1 to 4 carbon atoms, and x=0 or 1.

4. The poly(trimethylene terephthalate)-based composition of claim 3, wherein R, R¹ and R² are each CH₃, and X is 1.

5. The poly(trimethylene terephthalate)-based composition of claim 3, wherein R, R¹ and R² are each CH₃, and X is 0.

6. The poly(trimethylene terephthalate)-based composition of claim 1, wherein the poly(trimethylene terephthalate) is made by polycondensation of terephthalic acid or acid equivalent, and 1,3-propanediol.

7. The poly(trimethylene terephthalate)-based composition of claim 6, wherein the 1,3-propanediol is derived from a renewable source.

8. The poly(trimethylene terephthalate)-based composition of claim 1, wherein the poly(trimethylene terephthalate) is a poly(trimethylene phthalate) homopolymer.

9. The poly(trimethylene terephthalate)-based composition of claim 1, wherein the polymer component further comprises an additional polymer component.

10. The poly(trimethylene terephthalate)-based composition of claim 1, further comprising TiO₂.

11. The poly(trimethylene terephthalate)-based composition of claim 1, having reduced yellowness as compared to a composition comprising from about 95 to about 99.5 weight percent of a polymer component wherein the weight percent of the polymer component is based on the total composition comprising at least about 70 weight percent of a poly(trimethylene terephthalate) based on the polymer component in the absence of a cyclic phosphonic acid ester flame retardant compound.

12. A process for preparing a poly(trimethylene terephthalate)-based composition, comprising:
a) providing a cyclic phosphonic acid ester compound and polytrimethylene terephthalate;
b) mixing the polytrimethylene terephthalate and the cyclic phosphonic acid ester compound to form a mixture; and
c) heating and blending the mixture with agitation to form the composition.

13. An article made from the polytrimethylene terephthalate-based composition of claim 1.

14. The article of claim 13 in the form of a fiber.

15. A carpet or rug made from a fiber of claim 14.
